(19) United States
(12) Patent Application Publication
(10) Pub. No.: US 2009/0024432 A1
(43) Pub. Date: Jan. 22, 2009

(54) Business Process Management System and Method

(75) Inventors: Fred J. Bauters, Lisle, IL (US); Rory T. McClure, Buffalo Grove, IL (US); Jeffry A. Frederick, Aurora, IL (US); Christa A. Hoffmeier, Chicago, IL (US); Christopher J. Sifter, Itasca, IL (US); Otar Andjaparidze, Chicago, IL (US); John R. Gessler, Oswego, IL (US); Daryl B. Greer, Naperville, IL (US); Robert Johnson, Lafayette, CO (US)

Correspondence Address: BARNES & THORNBURG LLP, 600 ONE SUMMIT SQUARE, FORT WAYNE, IN, 46802, US

(73) Assignee: CROWE CHIZEK AND COMPANY, LLC, Oakbrook Terrace, IL (US)

(21) Appl. No.: 12/034,272

(22) Filed: Feb. 20, 2008

Related U.S. Application Data
(60) Provisional application No. 60/890,755, filed on Feb. 20, 2007.

(51) Int. Cl. G06Q 10/00; G06Q 40/00

(52) U.S. Cl. 705/8; 705/35

(57) ABSTRACT

A system and method for managing business processes. In one embodiment, electronic business rules are provided that define actions to execute a business process workflow. A workflow queue is provided with a plurality of actions for performing the business process workflow based on the electronic business rules. Typically, at least a portion of the actions are role-based. A user may navigate and select an outstanding action from the workflow queue based on a role associated with the user. A real-time status for each action in the workflow queue can be provided upon request.

### RELATED APPLICATIONS

The present application is related to and claims priority to U.S. Provisional Patent Application, Ser. No. 60/890,755, filed on Feb. 20, 2007, entitled Business Process Management System and Method. To the extent not included below, the subject matter disclosed in this application is hereby expressly incorporated into the present application.

### TECHNICAL FIELD

This disclosure relates generally to a system and method for managing business processes. Although this disclosure will be described in the context of processes relating to commercial loans, mortgages, customer due diligence, and accounts payable, this system and method could be used in conjunction with other business processes.

### BACKGROUND

Implementing business process management (“BPM”) can be one of the most rewarding initiatives an organization can perform. As a result, for many companies BPM has moved from a departmental consideration to an enterprise imperative. While it has tremendous payback, BPM can also be one of the most challenging implementations an organization can perform. Typically, each implementation may be treated as a custom development project, which results in the time, risk, and cost associated with those kinds of projects. Moreover, the development of these projects may be viewed as discreet solutions—with little consideration for reuse. Accordingly, each project involves a significant amount of custom programming and software development. Users also find it difficult to accurately define their initial requirements because the use of automation is so different from their current, manual world. Frequently, the new systems do not take advantage of the new technology, and replicate the manual processes rather than taking advantage of the technology to deliver a new way of approaching business problems.

In the context of commercial loans, for example, commercial lenders can no longer afford the traditional, manual approach to managing increasingly complex and customized commercial loans. As volumes grow, these lenders face a growing risk associated with manual data entry, lost documentation, and difficulty in complying with regulatory requirements such as Basel II. From a service perspective, commercial institutions using traditional manual-based systems are slow to respond to customer needs and have difficulty delivering the necessary product flexibility for competitive differentiation in a fluctuating market. Manual processing reduces the time customer relationship managers can spend on sales and limits revenue potential. Manual processing also presents a number of other challenges. For example, manual processing may create a number of duplicate steps, which increases workload and requires additional staff. This type of processing also makes monitoring status time consuming and decreases the responsiveness to customer needs. Moreover, manual processing creates an inability to monitor productivity levels or identify opportunities for process improvement. Further, creation of audit trails and consistent documentation is difficult, at best. In addition, the inability to integrate systems makes reliable monitoring of assets and covenants difficult, increasing risk to the lender. Typically, many commercial lending operations still rely on word-processing and spreadsheet programs and generate reams of paper to originate and renew commercial loans. This lack of automation reduces efficiency, weakens customer service, and makes regulatory compliance more challenging. Yet, because of the complex nature of commercial lending, few solutions are available. Moreover, processing of all the paperwork involved in mortgage and consumer lending—from customer documents such as W-2s and tax returns to third party documents such as appraisals, titles, and flood certifications—is usually done in post-close processing which is generally not part of an origination system. Accordingly, ensuring the closing documents and collateral received, properly signed, and recorded are usually manual functions.

In addition to the difficulties of processing loans, many financial service companies are struggling with the new requirements to take a risk-based approach for compliance with the USA Patriot Act. These companies are being asked to evaluate new and existing client and account relationships for money laundering and terrorist financing risk. Modern solutions require an integrated approach which involves many areas that have traditionally not been automated or integrating. This lack of automation reduces efficiency, damages customer experience, and makes regulatory compliance more challenging.

The processing of accounts payable and expense reporting is also difficult and time consuming. Manual tasks such as matching documentation to payment request, assuring the right people approve payment, addressing approval delays, and maintaining paperwork for the requisite amount of time all slow down the process. The process becomes even more difficult when complex invoices need to be improved by people in multiple departments.

Therefore, there is a need for a novel approach to increasing the efficiency of business processes.

### SUMMARY

According to one aspect, the disclosure provides a system and method for managing business processes. Typically, every document is electronically captured as soon as possible, whether faxed, mailed in, or electronically transferred through e-mail. This provides a time advantage since operational staff members no longer have to retrieve paper documents from a fax machine, transfer paper from person to person, or create folders and filing systems. As a result, documents can no longer be lost or mislaid. Data necessary for processing can be automatically retrieved from internal systems, such as those for customer relationship management (“CRM”), for loan origination and servicing, and for review and authorization. Loan information can be automatically transferred to loan documentation and loan servicing systems.

In some embodiments, data to be retrieved from external sources—such as credit reports, appraisals, and flood certifications—can be automatically ordered and retrieved through electronic systems integration. Accordingly, staff members no longer have to go to a separate system to access these documents.

Business and routing policies, including credit risk policies, can be formalized into electronic business rules, These rules then execute the workflow and ensure that work is executed as per policy. These business rules can be easily modified by business analysts to provide flexible, fast response to changing business conditions.

Management may obtain a real-time view into the status of each piece of work being processed. For each group, the system shows work in process, work waiting to be processed, the time each task is taking, and any delays or bottlenecks. This capability allows management of the process at a high level of detail and efficiency. Sales and operational staff can see the exact status of the work they are focused on. No longer do calls have to be made to determine where something is and who is working on it.

Additional features and advantages of the disclosure will become apparent to those skilled in the art upon consideration of the following detailed description of the illustrated embodiment exemplifying modes of carrying out the disclosure as presently perceived. It is intended that all such additional features and advantages be included within this description and be within the scope of the invention.

### BRIEF DESCRIPTION OF THE DRAWINGS

The present disclosure will be described hereafter with reference to the attached drawings which are given as non-limiting examples only, in which:

FIG. 1 is a block diagram of an example BPMS;

FIG. 2 is a block diagram of an example application server with a detailed representation of an example web application;

FIG. 3 is a block diagram of an example application server with a detailed representation of an example core framework;

FIG. 4 is a block diagram of an example data management scheme that may be used with the system;

FIG. 5 is a flow chart showing example actions that may be taken at steps in a workflow;

FIGS. 6-7 show the possible non-sequential nature of steps in the workflow;

FIG. 8 shows an example process flow of the web application;

FIG. 9 is a flow chart showing example steps that may be taken to configure a solution to a business process; and

FIG. 10 is an example BPMS configured with a variety of solutions.

The exemplification set out herein illustrates embodiments of the disclosure that is not to be construed as limiting the scope of the disclosure in any manner. Additional features of the present disclosure will become apparent to those skilled in the art upon consideration of the following detailed description of illustrative embodiments exemplifying modes of carrying out the disclosure as presently perceived.

### DETAILED DESCRIPTION

While the present disclosure may be susceptible to embodiment in different forms, there is shown in the drawings, and herein will be described in detail, embodiments with the understanding that the present description is to be considered an exemplification of the principles of the disclosure and is not intended to be exhaustive or to limit the disclosure to the details of construction and the arrangements of components set forth in the following description or illustrated in the drawings.

As should be appreciated by one skilled in the art, the present disclosure may be embodied in many different forms, such as one or more devices, methods, data processing systems or program products. Accordingly, the embodiments may take the form of an entirely software embodiment or an embodiment combining hardware and software aspects. Furthermore, embodiments may take the form of a computer program product on a computer-readable storage medium having computer-readable program code embodied in the storage medium. Any suitable storage medium may be utilized, including read-only memory (“ROM”), random access memory (“RAM”), dynamic random access memory (“DRAM”), synchronous dynamic random access memory (“SDRAM”), hard disk(s), CD-ROM(s), DVD-ROM(s), any optical storage device, and any magnetic storage device.

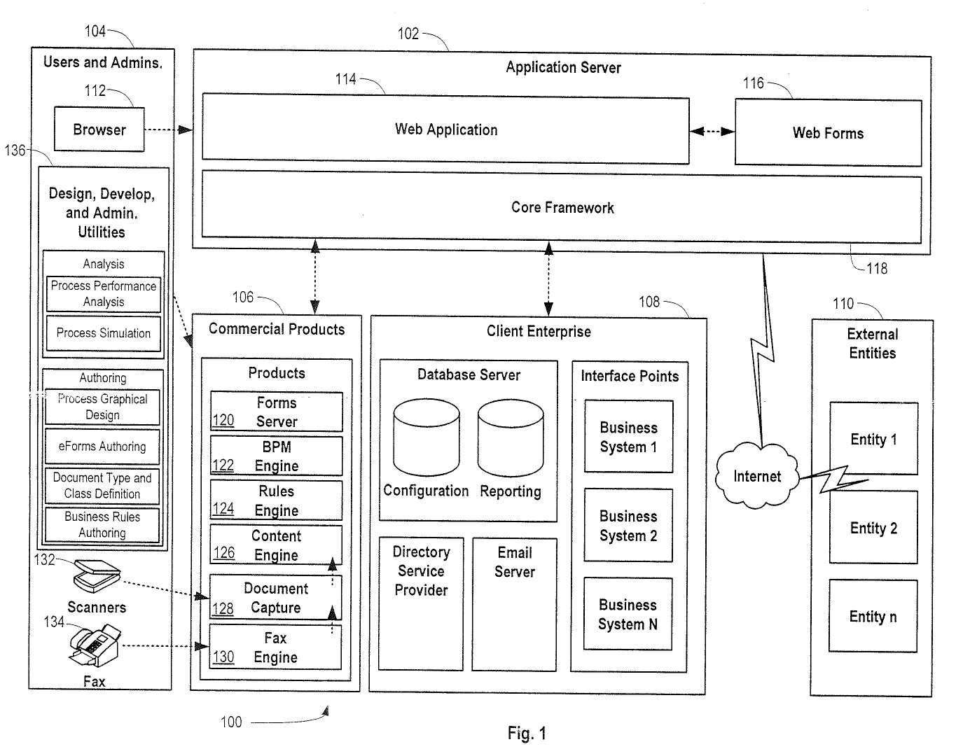

FIG. 1 shows a business process management system (“BPMS”) 100 in accordance with one illustrative embodiment that may be used to design, develop, access and analyze automated business processes, along with other functions described below. In the embodiment shown, the BPMS 100 includes an application server 102, a user and administrator module 104, commercial products 106, a client enterprise 108, and external entities 110. Although each of these components 102, 104, 106, 108 and 110 are represented by a single block in FIG. 1 for purposes of example, the operation of each of these components 102, 104, 106, 108 and 110 may be distributed among a plurality of computing devices. For example, it should be appreciated that various subsystems (or portions of subsystems) of the BPMS 100 may operate on different computing devices. In some such embodiments, the various subsystems of the BPMS 100 may communicate over a network.

In the example shown, one or more users may connect to the application server 102 using a browser 112. For example, the browser 112 may be but is not limited to a web browser, such as Internet Explorer by Microsoft Corporation of Redmond, Wash.. The browser 112 may include plugins, such as Adobe Acrobat Reader by Adobe Systems, Inc. of San Francisco, Calif.. The browser may be on viewed any computing device, such as but not limited to a personal computer, kiosk, workstation, personal digital assistant (“PDA”), or cellular phone.

The application server 102 may include a web application 114 that provides a user interface which allows users to interact with the BPMS 100. The web application 114 could be used by the user to perform a variety of functions, including but not limited to searching for documents, managing work, browsing the queue, reassigning tasks, etc. In the embodiment shown, the web application 114 is operable to communicate with web forms 116 which allows users to retrieve and interact with forms through the web application 114.

The application server 102 may include a core framework 118, which could be configured to interface with the web application 114 to respond to use of the user interface. As shown, the core framework 118 may communicate with the commercial products 106, client enterprise 108 and external entities 110 to perform various functions, as described below.

In the embodiment shown, the commercial products 106 include by way of example and not limitation, a forms server 120, a business process management (“BPM”) engine 122, a rules engine 124, a content engine 126, document capture 128, and fax engine 130. The forms server 120 may be operable to provide a variety of forms to a user. The BPM engine 122 may be configured to manage work flow, work queues and work assignments and other elements relating to business processes. The rules engine 124 may be configured to control the business rules associated with a business process. The content engine 126 may be configured to provide content, including but not limited to forms, and other data related to a business process. The document capture 128 and fax engines 130 may be used to import content from scanners 132 and faxes 134, respectively.

The user and administrator module 104 may include utilities 136 operable to allow a user to design and develop business process management solutions. Typically, the utilities 136 allow users to develop the solutions through configuration of forms and business rules, rather than using a programming language. This allows business analysts, without any programming experience, to create solutions. The utilities 136 may also be operable to administer the solutions.

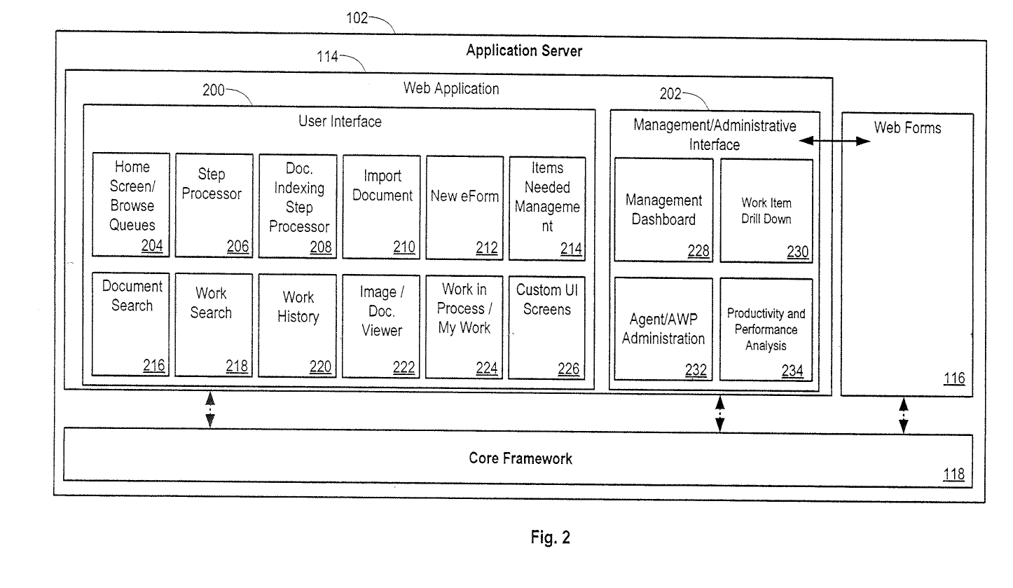

FIG. 2 is a block diagram of an example application server 102 with a detailed view of an example web application 114. In the example shown, the web application 114 includes a user interface 200 and a management/administrative interface 202. It should be appreciated that the components of the interfaces 200 and 202 could include additional components not shown or have only a few of the listed components.

The user interface 200 allows the user to perform desired actions, including but not limited to managing personal workflow, performing task in the workflow queue, etc. The user interface 200 may include but is not limited to a home screen module 204, a step processor 206, a document indexing step processor 208, an import document module 210, a new eform module 212, an items needed management module 214, a document search module 216, a work search module 218, a work history module 220, an image/document viewer 222, a work in progress module 224 and optional custom screens 226.

The home screen module 204 is typically the default view that a user sees upon logging into the web application 114. The home screen module 204 may be configured to allow the user to browse through workflow queues associated with the user. In some cases, the user may view notifications from the home screen module 204, including but not limited to, notifications when work associated with the user enters or exits the queue.

The step processor 206 allows a user to select work to be performed from the workflow queue. The step processor 206 typically has different configurations based on the work selected from a queue, including but not limited to displaying summary data about a case and having buttons that connect to workflows.

The step processor 206 may be operable to allow the user to browse a queue and obtain work from the selected queue, including but not limited to selecting ‘get next’ from a queue, subselecting the ‘get next’ function, selecting from a ‘browse queue’, or having a ‘personal queue’ from which the user could get ‘personal’ items from general queue. In some cases, the user may be associated with a role (or multiple roles), which provides different screen configurations based on a particular role.

The step processor 206 could be configured to display a default document or default form. In some cases, the step processor 206 could be operable to display a list of all documents, forms and/or data available for a case. Typically, the step processor 206 provides instructions that help a user complete a task. In some cases, the step processors 206 allow the user to enter comments.

The document indexing step processor 208 may be operable to index a variety of data associated with tasks, data, forms, etc, including by not limited to indexing data entry screens, indexing a package of documents with similar attributes and providing integration to validate index values.

The import document module 210 may be operable to retrieve documents to be used in a task. The new eform module 212 may be configured to create new electronic forms, such as for data entry.

The items needed management module 214 may present the user with a list of items needed for a workflow based on business rules associated with the workflow or based upon items manually added by the user. In some cases, ticklers may be provided to remind the user of overdue items needed. Depending on the circumstances, the items needed may be “checked off” automatically based on the receipt of documents. Typically, the items needed management module 214 will be configured to report the status of items needed. In some cases, a workflow may be initiated based on the addition of items needed. In some embodiments, the items needed management module 214 may provide gated execution of workflows based upon items needed at that step. In some cases, the items needed management module 214 may allow for waiver of items needed to later steps.

The document search module 216 allows a user to find and display documents, forms and data. The work search module 218 allows a user to find all workflows for a case. Typically, the work search module 218 is operable to display steps that have been executed and their details for each workflow.

The work history module 220 allows the user to view tasks that have been performed. In some cases, performance statistics or other data may be available to the user with respect to the work history. The image/document viewer 222 allows the user to view documents, images, and/or other data.

The work in progress module 224 is operable to list all work associated with a user. Typically, the user may also view the status of the work. In some cases, the work in progress module 224 may provide shortcuts to the documents and items needed in the work list associated with the user. Embodiments are contemplated in which the user may receive a notification (such as an email) when a work item enters or exits a queue.

The management/administrative interface 202 may include, but is not limited to a management dashboard 228, a work item drill down 230, an agent administration module 232, and a productivity analysis module 234. In some cases, the management dashboard 228 is operable to display the current status of all items in queues that the user has access to and provides access to all case information. The work item drill down module 230 may display the details of work in all queues to which the user has access. In some cases, such as when a bottleneck in workflow is detected, the management dashboard 228 may allow reassignment of work. The productivity analysis module 234 may be configured to measure productivity and performance of work items in the queue, such as to attempt to find bottlenecks in a workflow.

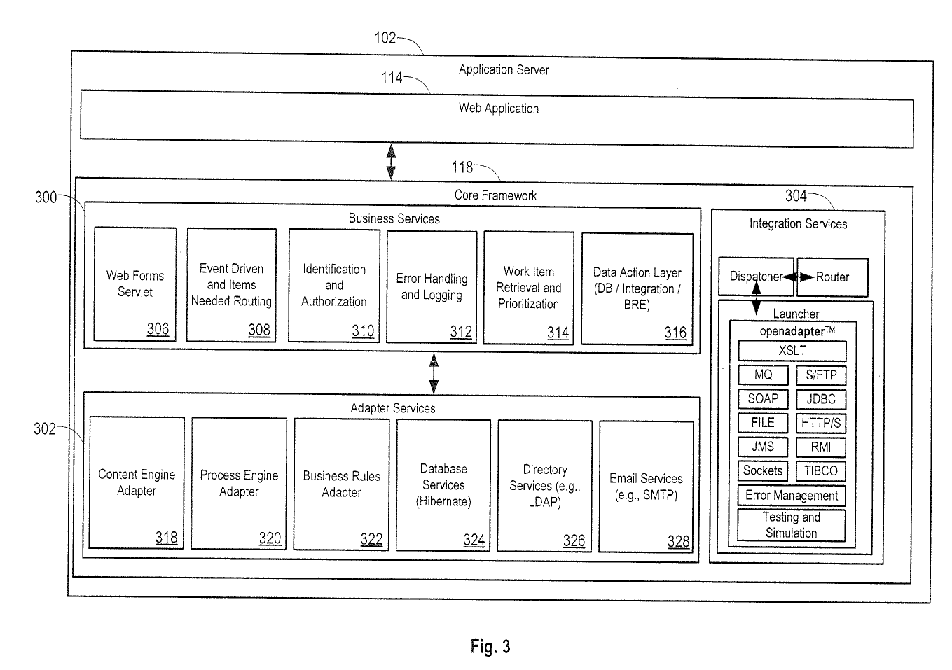

FIG. 3 is a block diagram of an example application server 102 in which an example core framework 118 is shown in detail. The core framework 118 may include, but is not limited to, a business services layer 300, an adapter services layer 302, and an integration services layer 304.

In some embodiments, the business services layer 300 may include, but is not limited to a web forms servlet 306, events module 308, security module 310, auditing module 312, workflow module 314, and data action layer 316. The web forms servlet provides access, editing and design to various forms that may be associated with the BPMS 100. The events module 308 may be configured to provide routing of work items. In some cases, the events module may be events driven based upon business rules and/or route work items based on items needed. The security module 310 may be operable to identify and authorize users, which may affect the work items, queues and other data to which the user is provided access. The work flow module 314 may be configured to retrieve work items from a queue and prioritize work items based on business rules, items needed or other criteria. The audit module 312 provides error handling and logging of actions performed by the user and/or components in the BPMS 100. In some cases, the audit module 312 provides Excel based management reporting. Embodiments are also contemplated in which the audit module 312 could store all step audit information in a FileNet Audit Log. Typically, the audit module 312 would support the FileNet process analyzer for management reporting and the FileNet process simulator. The data action layer 316 may be configured to store relationship information about related documents.

The adapter services layer 302 provides insulation to changes in APIs, such as changes to FileNet APIs. Additionally, the adapter services layer 302 supports multiple rules and multiple forms from vendors. As shown, the adapter services layer 302 includes a content engine adapter 318, a process engine adapter 320, a business rules adapter 322, database services 324, directory services 326, and email services 328.

The content engine adapter 318 provides an interface with one or more content engines, such FileNet P8 content engine by IBM, Mobius by Mobius Management Systems, Inc. of Rye, N.Y., and IBM Content Manager. The content engine adapter 318 may be operable to provide bar coded cover sheet creation and letter creation. The process engine adapter 320 may be operable to interface with one or more process engines, such as FileNet P8 Process Engine by IBM, Tibco Staffware iProcess by the BPM Group of Burlington, Mass. and IBM WebSphere Workflow. The business rules adapter 322 may be configured to interface with one or more business rules engines, such as Corticon by Corticon Technologies, Inc. of Redwood City, Calif. and ILog by ILog, Inc. of Mountain View, Calif. The database services 324 may be configured to interface with one or more types of databases, such as a configuration database and a reporting database. Typically, the database services 324 supports versioning for case data and stores form data as XML in content engine. The directory services 326 may be configured to allow interfacing with a variety of directory services, such as Microsoft's Active Directory, Novell eDirectory and Sun Java Directory. Typically, the directory services 326 supports lightweight directory access protocol (“LDAP”). The email services 328 may be configured to provide messaging, such as electronic mail, through a variety of email servers, such as Microsoft Exchange, Novell Groupwise and Lotus Notes.

The integration services 304 are operable to provide configurable integration that is consistent throughout the web application 114. Typically, the integration services 304 provide configurable integration for forms and workflows that supports all major protocols. In some cases, the integration services 304 may provide an interactive testing tool and a graphical user interface for configuration. In some embodiments, the integration services 304 supports high performance parsing of strings, which may be necessary for ACAPS MQ Series transactions. Typically, the integration services 304 supports all four paths of integration (i.e., originate round-trip, originate one-way, respond round-trip, respond one-way). In some cases, the integration services 304 may support data segments that are split over multiple messages, which may be necessary for ACAPS MQ Series transactions.

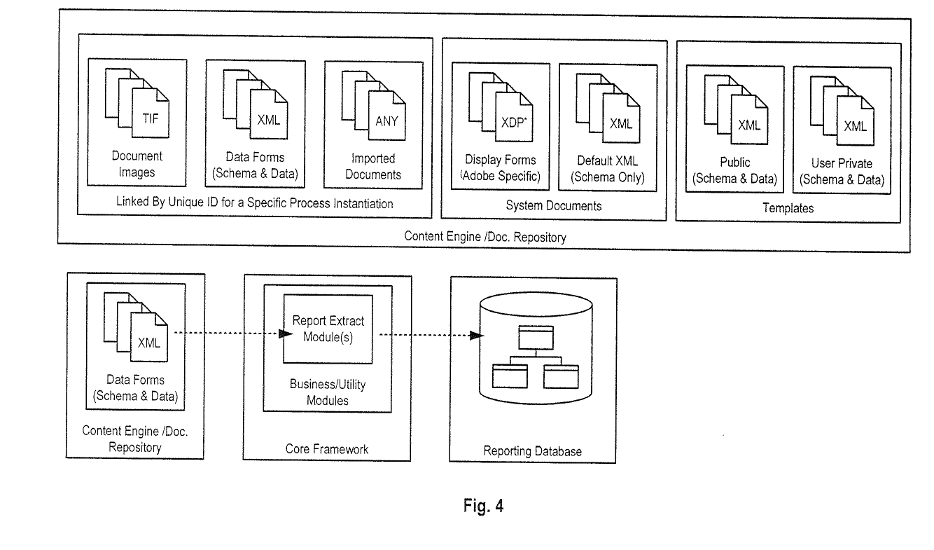

FIG. 4 shows an example data management scheme for use with the BPMS 100. In this example some documents, forms and images may be linked by a unique identifier for a specific process instantiation. As shown, form data is stored in the content engine in XML format.

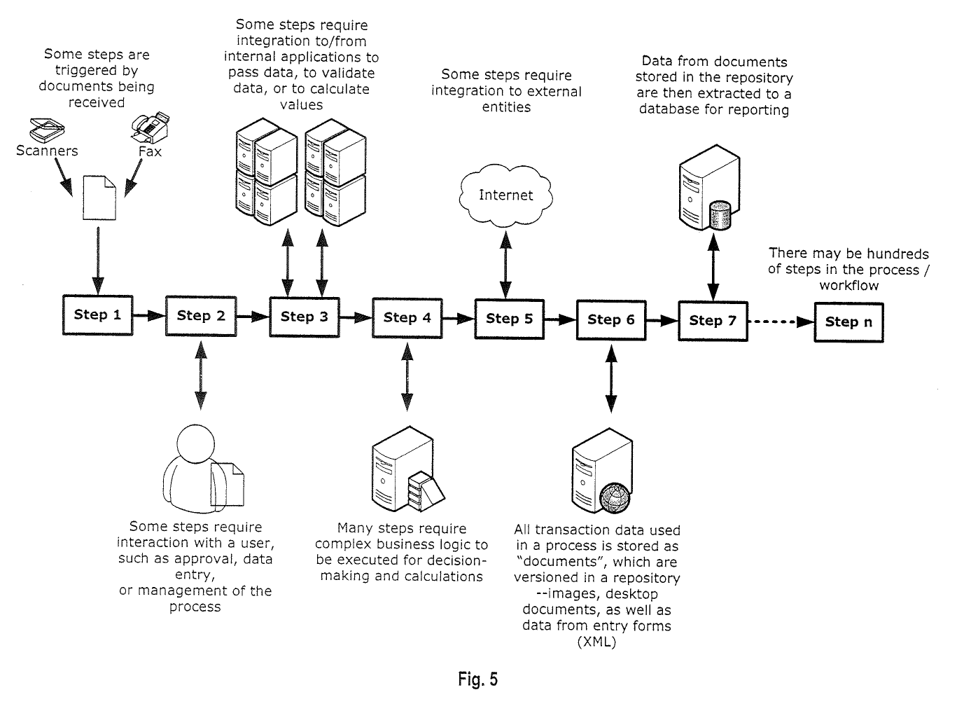

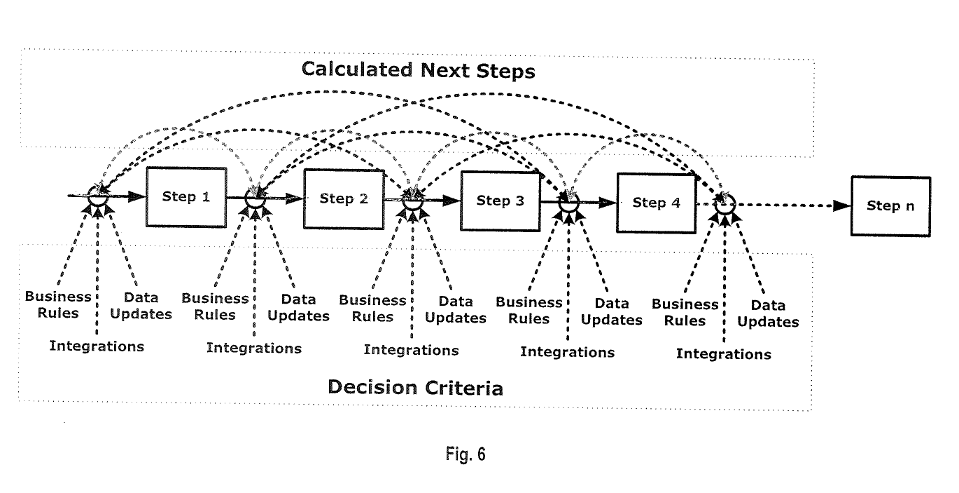

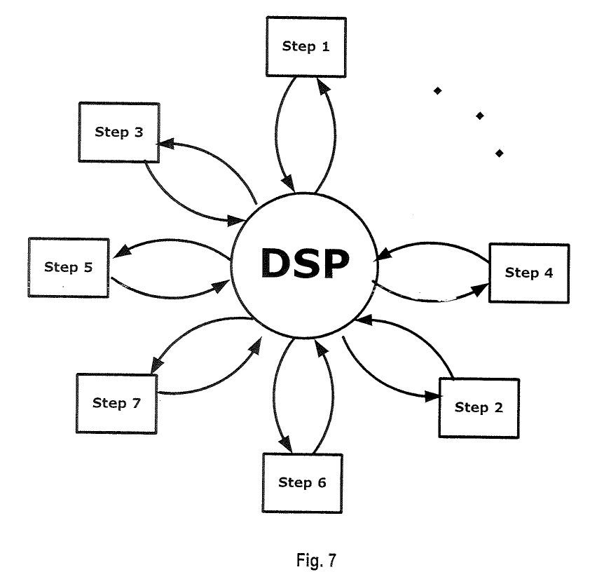

FIG. 5 shows an example process flow for a business process. It should be appreciated that this process flow is shown solely for purposes of example and does not limit the possible actions that could be taken for each step in a business process. In the example shown, there may be one or more different actions for each step in the business process, depending on business rules, items needed, etc. As can be seen by the examples in FIG. 5, steps may include, but are not limited by, steps triggered by certain events, steps requiring further attention by a user, the application of business logic, integration to external entities, storage of data or other events. As seen in FIGS. 6 and 7, the steps need not be performed in a sequential manner. Instead, a determination may be made, based on business rules, integrations, and data updates, as to other steps that may be performed.

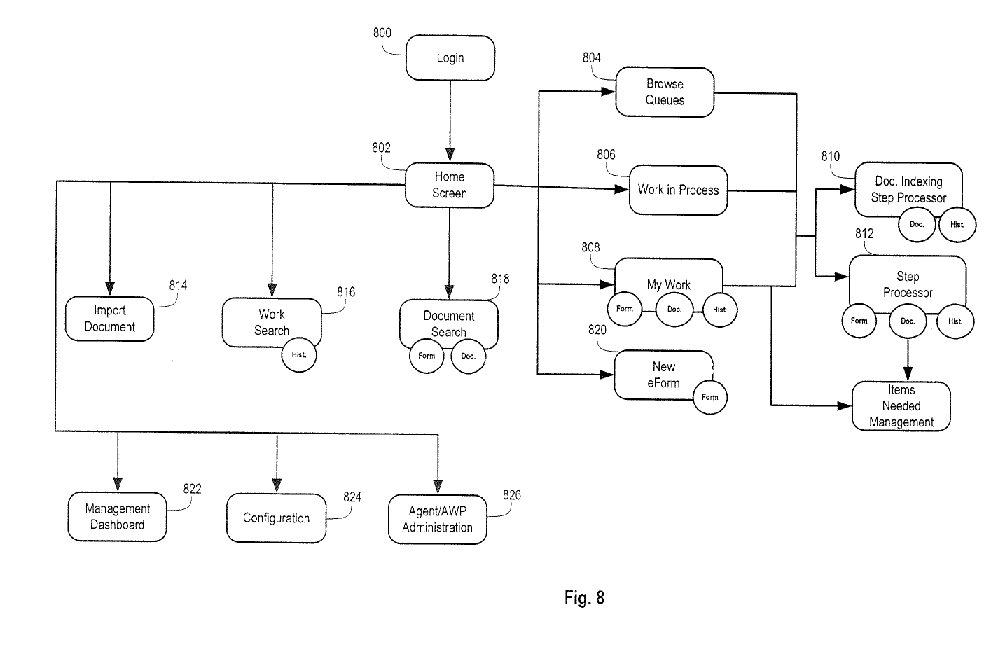

FIG. 8 shows a flow diagram of possible user actions with the web application 114. It should be appreciated that this is shown solely for purposes of example and does not limit the possible user actions that could be taken. In this example, the user initially logs in to the BPMS 100, as shown in step 800, which typically would include authorization through a password, etc. Upon login, the user is presented with a home screen, as indicated by step 802 from which the user may select a variety of actions. For example, the user may browse the queues to which the user has access, as indicated in step 804. The user may check on work in process to determine the status of items in the process of being completed, as indicated by step 806. The user may select work associated with the user, as indicated by step 808. For example, there may be shortcuts to forms, documents and work history for the user to access. When the user selects any of steps 804, 806 and 808, the document indexing step process and step process are used to display and index the information for the user, as indicated by steps 810 and 812. From the home screen, the user may also select to import documents, as indicated by step 814, search work items associated with the user, as indicated by step 816 or search documents, as indicated by step 818. In addition, as shown in this example, the user may select to create/enter data into a new electronic form, as indicated by step 820. If the user is authorized as an administrator (or other role authorized to perform management/administrative functions), the user may use the management dashboard (step 822), configure the process or workflow (step 824), or perform administrative functions (step 826).

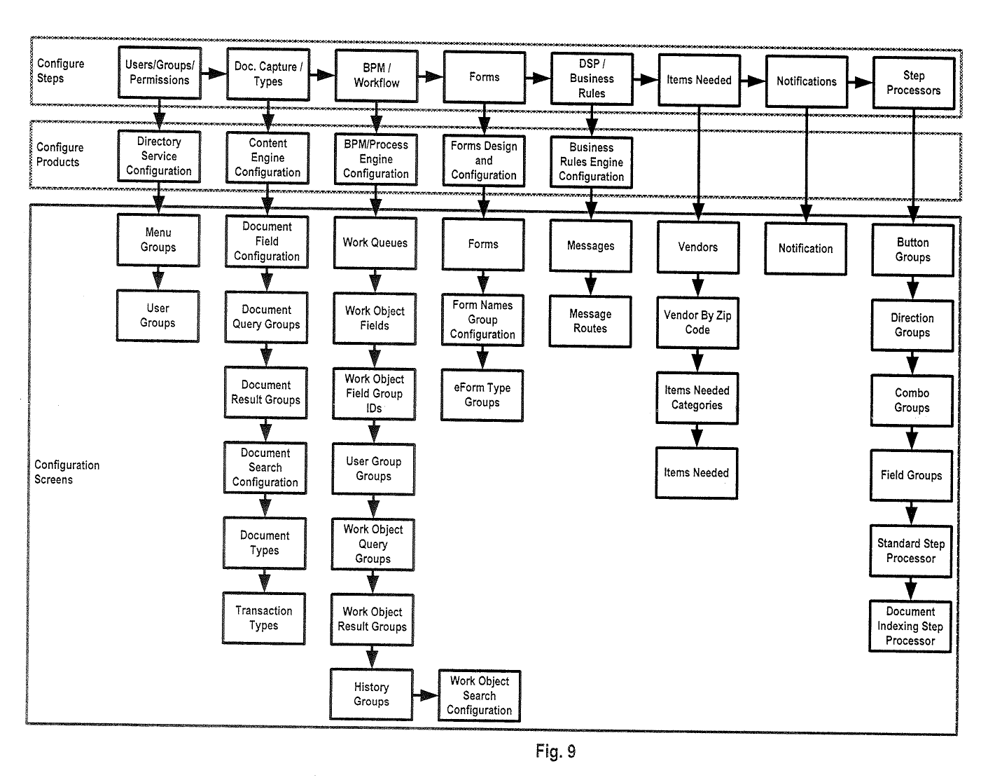

FIG. 9 shows examples steps that may be performed to configure a business process solution. As can be seen, the solution is configured, rather than a custom program, which allows non-programmers to create solutions.

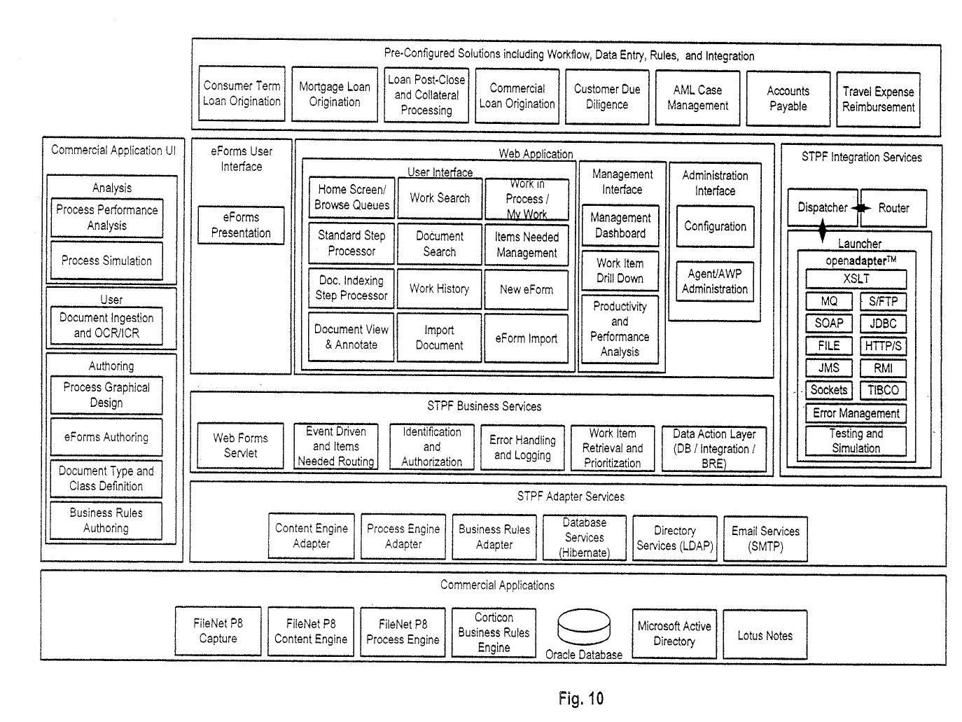

FIG. 10 shows an example BPMS 100 that is preconfigured with solutions that automate consumer term loan origination, mortgage origination, loan post-close and collateral processing, commercial loan origination, customer due diligence, AML case management, accounts payable and travel expense reimbursement.

With respect to the consumer and commercial lending solutions, the solution automates the entire origination process, from deal inception to booking. The solution supports complex group credits. Functionality includes loan approvals with multiple obligors, obligations, and items of collateral, and supports the complex relationships between them. The solution supports all sizes and types of credit from business banking through mid-market to large syndications and provides automated initiation of renewals and reviews and includes loan servicing for collateral management. Each loan is routed through the appropriate steps based on credit size and other attributes. An integrated rules engine defines, enforces, and maintains policies. Data entry is reduced through automated integration with financial spreading tools and profitability analysis systems. In addition, automated integration with document preparation and loan servicing systems reduces operational risk. The solution tracks each item needed to complete the loan including financial statements, appraisals, and closing documents, and reports on its status. The solution also assists with post-close collateral perfection.

This solution allows for customization to address the specific needs of each lending institution so that lenders can automate their loan processes, while maintaining an individualized approach that improves process efficiencies and bottom-line profitability. By implementing this solution, lenders can achieve numerous benefits. For example, customers benefit from improved quality, speed and service effectiveness. Relationship managers benefit because loan information only needs to be entered once—the information needed in multiple systems is automatically transferred through electronic integration. Renewals and reviews are copied into the system from the servicing system based on original data entered and current loan status. Repetitive tasks can be offloaded from the relationship managers and centralized because any user with appropriate authority has access to the entire set of customer and loan information. Customer service and loan operations benefit from real-time status into actual loan status, and from improved operational efficiency through staff redeployment, reduction in duplicated efforts, faster loan processing, and improved data integrity. Management benefits from accurate insight into process status, pipeline activities, and throughput metrics, enabling the ability for continuous process management and improvement. Compliance improves through consistent and transparent underwriting and documentation processes, ensuring compliance with regulatory requirements, including Sarbanes-Oxley and Basel II.

The example in FIG. 10 includes a mortgage loan origination solution, which addresses all of the paper associated with the loan—from origination through post-close processing. It also supplements existing systems with automated integration to third-parties and handles collateral recording and perfection. During loan origination, the system captures all customer paper electronically, making it available for each downstream process. Third-party documents can be automatically ordered and captured electronically so that underwriting and document preparation organizations can work from the electronic record. Business rules control which third-party documents need to be ordered based on loan attributes and processing stage. The solution is especially valuable during post-close processing. Business rules can determine if all necessary documents have been returned and generate letters for exception processing. Workflows can be automatically driven based on the type of loan and type of collateral. Perfection of collateral is tracked with “ticklers” generated for items past due. The solution also provides automated interfaces to third-party organizations that work with collateral. In the case of consumer auto loans, the entire title registration can be done for those states that support it through automated vendors for Uniform Commercial Code filing and auto titles.

This solution provides numerous benefits. For example, the application is already developed and can be adapted to a client environment without coding in Java or .Net. Many of the integrations are already built, with interfaces to applications such as ACAPS and LaserPro and third-parties for credit reports, and title and flood services organizations. Every document is electronically captured as soon as possible, whether faxed, mailed in, or electronically transferred through e-mail. Operational staff members no longer have to retrieve paper documents from a fax machine, transfer paper from person to person, or create folders and filing systems. As a result, documents can no longer be lost or mislaid. Data necessary for processing can be automatically retrieved from internal systems, such as those for customer relationship management (“CRM”), for loan origination and servicing, and for review and authorization. Loan information can be automatically transferred to loan documentation and loan servicing systems. Data to be retrieved from external sources—such as credit reports, appraisals, and flood certifications—can be automatically ordered and retrieved through electronic systems integration. Staff members no longer have to go to a separate system to access these documents. Business and routing policies, including credit risk policies, can be formalized into electronic business rules. These rules then execute the workflow and ensure that work is executed as per policy. These business rules can be easily modified by business analysts to provide flexible, fast response to changing business conditions. Management obtains a real-time view into the status of each piece of work being processed For each group, the system shows work in process, work waiting to be processed, the time each task is taking, and any delays or bottlenecks. This capability allows management of the process at a high level of detail and efficiency. Sales and operational staff can see the exact status of the work they are focused on. No longer do calls have to be made to determine where something is and who is working on it. All of the system data and documents are available wherever there is a network, allowing work to be done at any location. Work can be automatically routed to various locations based on type of work, time of day, work load, or any attribute of the loan. Real-time process management allows for review of processing effectiveness from any authorized desktop.

The example BPMS 100 shown in FIG. 10 also includes solutions for accounts payable and travel expense reimbursement. These solutions solve problems typically associated with manual processing by capturing payment requests using electronic web-based forms, and automatically capturing and matching them with supporting documents. The solutions automatically route approvals to the appropriate person, and payment requests can be simultaneously routed in the case of multiple approvers. The system retains all documents and approvals, and anyone with sufficient authority can conduct queries. Interfaces to the accounts payable system and approval databases are also included. This provides numerous benefits. For example, the application is already developed and can be adapted to a client environment without coding in Java or .Net. Every document is electronically captured as soon as possible, whether faxed, mailed in, or electronically transferred through e-mail. Operational staff members no longer have to retrieve paper documents from a fax machine, transfer paper from person to person, or create folders and filing systems. As a result, documents can no longer be lost or mislaid. The system electronically interfaces with vendor masters and approval masters for data selection and validation. Invoices are automatically transferred into the accounts payable system. Business and routing policies can be formalized into electronic business rules. These rules then execute the workflow and ensure that work is executed as per policy. These business rules can be easily modified by business analysts to provide flexible, fast response to changing business conditions. Management obtains a real-time view into the status of each piece of work being processed. For each group, the system shows work in process, work waiting to be processed, the time each task is taking, and any delays or bottlenecks. This capability allows management of the process at a high level of detail and efficiency. Users and operational staff can see the exact status of the work they are focused on. No longer do calls have to be made to determine where something is and who is working on it. Work anywhere, any time. All of the system data and documents are available wherever there is a network, allowing work to be done at any location. Work can be automatically routed to various locations based on type of work, time of day, work load, or any attribute of the loan. Real-time process management allows for review of processing effectiveness from any authorized desktop.

The example BPMS 100 shown in FIG. 10 also includes a solution to customer due diligence. The solution supports all types of customer risk ratings and includes built-in risk scoring to evaluate customers for AML risk. Workflow routes potentially high-risk customers through the appropriate review and decision steps based on bank policy. The solution is flexible and can quickly change workflow, business rules, notification, and scoring factors. It issues automated alerts and follow ups for enhanced due diligence and case management. The solution is secure as providing the right view of customer information to the right people in the organization. The solution also guards customer privacy and simplifies the customer's ability to expand relationships with a lending/banking institution. Since the solution is policy driven, the policies can be defined and enforced. The solution maintains policies through the integrated rules engine. The solution also supports integration with major transaction monitoring vendors and allows you to prioritize alerts and use a common case management solution if desired. The solution may also include a built-in scoring system to determine objectively which customers present higher risks. Lending institutions can then build this risk rating into policies and procedures for account reviews and transaction monitoring. The solution ensures accountability by tracking changes and ensuring the information is completed according to an institution's BSA/AML policies and procedures. Built-in reporting and workflow features provide alerts to noncompliant documentation. The solution also helps preserve the customer experience and strengthen customer relationships. Customers, for example, are not asked the same questions twice. The same rules engine that helps identify risks can also help structure the conversation and identify potential products and services. The solution is designed to be implemented in phases, so an institution can reach basic compliance rapidly, and then build on the solution for long-term benefit.

While this disclosure has been described as having an exemplary embodiment, this application is intended to cover any variations, uses, or adaptations using its general principles. It is envisioned that those skilled in the art may devise various modifications and equivalents without departing from the spirit and scope of the disclosure as recited in the following claims. Further, this application is intended to cover such departures from the present disclosure as come within the known or customary practice within the art to which it pertains.

1. A method for managing a business process across an enterprise, the method comprising the steps of:
(a) providing electronic business rules that define actions to execute a business process workflow;
(b) providing a workflow queue having a plurality of actions for performing the business process workflow based on the electronic business rules, wherein at least a portion of the actions are role-based;
(c) allowing a user to navigate and select an outstanding action from the workflow queue based on a role associated with the user;
(d) receiving a request for a status of one or more actions in the workflow queue; and
(e) presenting a real-time status for each action in the workflow queue for which a status was requested.

2. The method of claim 1, wherein the real-time status includes a list of actions that are in process and those actions that are waiting to be processed.

3. The method of claim 1, wherein the real-time status includes an amount of time that has been spent on each action.

4. The method of claim 1, further comprising the step of allowing a user to reprioritize actions in the workflow queue based on the real-time status.

5. The method of claim 1, wherein the workflow queue is configured to automatically route actions to users based on the time of day.

6. The method of claim 1, further comprising the step of allowing a user to modify the electronic business rules without performing any computer programming.

7. The method of claim 1, wherein the user is allowed to select an outstanding action from the workflow queue in a non-sequential manner, so long as the selected action is not dependent on another action that has not been completed.

8. The method of claim 7, wherein the workflow queue is configured to automatically route actions to users based on work load of users.

9. The method of claim 1, wherein the electronic business rules define actions needed to process at least one of a consumer loan, commercial loan and a mortgage.

10. The method of claim 9, wherein the electronic business rules include actions to be completed both pre-closing and post-closing.

11. The method of claim 10, wherein the workflow queue is configured to track whether one or more post-closing actions have been completed.

12. The method of claim 11, wherein the workflow queue is configured to track whether properly signed closing documents have been received.

13. The method of claim 11, wherein the workflow queue is configured to determine whether post-closing perfection of collateral has been completed.

14. The method of claim 13, wherein the workflow queue is configured to generate a reminder action if perfection of collateral is not completed within a predetermined time period.

15. The method of claim 14, further comprising the step of automatically electronically filing title registration concerning a loan.

16. The method of claim 9, wherein the electronic business rules are configured to automatically order and electronically capture third party documents needed to process a mortgage.

17. The method of claim 16, wherein the electronic business rules are configured to define actions to be taken post-closing of a mortgage.

18. The method of claim 17, wherein the electronic business rules are configured to automatically generate reminder letters if one or more post-closing actions are not completed within a predetermined time period.

19. The method of claim 9, wherein the electronic business rules are configured based on at least one of a loan type and collateral type.

20. A business process management system comprising:
a rules engine configured to define a workflow for a business process, wherein the business process is selected from at least one of a consumer loan, commercial loan and a mortgage;
a workflow queue configured to track actions needed to be completed in the workflow;
an items needed management module configured to present a user with a list of items needed for the workflow, wherein the items needed management module is configured to remind the user of overdue items needed;
a productivity analysis module configured to measure performance of actions in the workflow queue; and
wherein the items needed management module is configured to track both pre-closing and post-closing items in the workflow.
